(19) United States
(12) Patent Application Publication
(10) Pub. No.: US 2014/0266020 A1
(43) Pub. Date: Sep. 18, 2014

(54) WIRELESS CHARGING PAD AND METHOD

(71) Applicant: NXP B. V., Eindhoven (NL)

(72) Inventors: Johannes Petrus Maria van Lammeren, Beuningen (NL); Klaas Brink, Waalre (NL); Aliaksei Vladimirovich Sedzin, Eindhoven (NL)

(73) Assignee: NXP B. V., Eindhoven (NL)

(21) Appl. No.: 13/802,909

(22) Filed: Mar. 14, 2013

(51) Int. Cl. H02J 7/02

(52) U.S. Cl. CPC H02J 7/025
USPC 320/108; 320/137

(57) ABSTRACT

A wireless charging pad is illustratively disclosed. In an embodiment, the pad includes an NFC tag which is capable of receiving an NFC signal from the receiver and thereby turning on the pad's power supply to commence charging of the receiver.

### FIELD OF THE INVENTION

This invention generally relates to wireless charging pads and methods for their use. More particularly, this invention relates to wireless charging pads and methods which reduce or eliminate consumption of standby power.

### BACKGROUND OF THE INVENTION

Many equipments or devices, including, for example, mobile phones and electronic equipment, to name but a few, contain rechargeable batteries. An increasingly popular method of recharging such rechargeable batteries is wireless or inductive charging.

An example of the use of wireless charging is provided in U.S. Pat. No. 8,212,518. It is common to refer to the charging apparatus as the “transmitter” or “charging pad” or “pad” and to the device or equipment being charged as the “receiver”. Both the receiver and the pad typically have respective coils between which energy for charging the receiver's battery is transferred via inductive or other coupling.

One drawback to wireless charging, in general, is inefficiency. There are at least two reasons for such inefficiency. First, the wireless charging process itself can consume between 5% and 30% more power than a wired charging process. Second, a pad is typically in standby mode when it is not charging a receiver. However, in standby mode, the pad must consume energy to determine if a receiver has been positioned in contact with or in proximity to the pad. Often the pad sends out pulses on a regular basis to determine whether a receiver is nearby or in contact with the pad. In practice, the energy loss consumed in standby mode may be equal to the energy needed to charge the receiver.

Of course, a pad may be equipped with a mechanical switch to turn the pad on. However, those concerned with the advance of wireless charging have sought other convenient approaches.

### SUMMARY OF THE INVENTION

In an exemplary embodiment, the invention includes a wireless charging pad having: a power supply; a switch connected to the power supply and capable of turning the power supply on; an NFC tag positioned proximate the switch and capable of turning the switch on in response to an NFC signal. Additional embodiments include a transistor as the switch.

Furthermore, there is disclosed a method of charging a receiver which includes: providing a charging pad having a power supply; a coil connected to the power supply; a switch connected to the power supply and capable of turning the power supply on; an NFC tag positioned proximate the switch and capable of turning the switch on in response to an NFC signal; whereby if a receiver having NFC transmitting capability is positioned proximate the pad and the receiver transmits an NFC signal, the transistor will turn on the power supply which will energize the coil and charge the receiver.

### BRIEF DESCRIPTION OF THE DRAWINGS

FIG. 1 is a circuit diagram of an exemplary embodiment of the invention.

### DETAILED DESCRIPTION OF ILLUSTRATIVE EMBODIMENTS

Another approach to wireless charging is to equip the receiver so that it can initiate the charging process. However, if the pad is turned off, it cannot receive and act upon any signals emitted from the receiver.

In one embodiment of the present invention, the pad includes a passive NFC tag. The NFC tag is desireably located on or near the power transfer coils of the pad. The receiver is also equipped with NFC functionality. The receiver is capable to sending an NFC signal to the pad. The NFC tag in the pad utilizes energy from the NFC field (created by the receiver) to activate a switch which turns on the power supply to the pad.

More particularly, in FIG. 1, reference numeral 11 denotes a charging pad. Pad 11 contains a power supply 13 which is connected to one or more charging coils 20. NFC antenna 15 is connected to passive NFC tag 17. NFC tag 17 controls a switch (herein, transistor 19) which turns power supply 13 on and off. Other switching devices capable of operating upon energy harvested from the NFC tag, such as relays may be utilized.

In a preferred embodiment, the switch is connected to the primary side of the pad's power supply 13. There may be certain cases in which such primary side connection is not possible. In some embodiments, the pads are not connected directly to power mains, but are supplied via a transformed 5 volt supply. In such embodiments, the pad can still be made to have zero standby power, but there will be losses in the transformer.

In certain embodiments, reference numeral may denote a battery or capacitor which may be recharged or energized by a separate power supply.

In operation, the receiver, using what is left of its battery power, transmits an NFC signal which is received by passive NFC tag 17 via antenna 15. Energy from the NFC field turns on transistor 19. Transistor 19 turns on power supply 13 which energizes charging coil 20, thereby enabling charging of the receiver.

In further embodiments, the receiver may transmit via NFC additional information about the receiver, such as the manner in which the receiver is to be charged; information about the receiver itself; various information about standards applicable to the receiver, etc.

Various exemplary embodiments are described in reference to specific illustrative examples. The illustrative examples are selected to assist a person of ordinary skill in the art to form a clear understanding of, and to practice the various embodiments. However, the scope of systems, structures and devices that may be constructed to have one or more of the embodiments, and the scope of methods that may be implemented according to one or more of the embodiments, are in no way confined to the specific illustrative examples that have been presented. On the contrary, as will be readily recognized by persons of ordinary skill in the relevant arts based on this description, many other configurations, arrangements, and methods according to the various embodiments may be implemented.

To the extent positional designations such as top, bottom, upper, lower have been used in describing this invention, it will be appreciated that those designations are given with reference to the corresponding drawings, and that if the orientation of the device changes during manufacturing or operation, other positional relationships may apply instead. As described above, those positional relationships are described for clarity, not limitation.

The present invention has been described with respect to particular embodiments and with reference to certain drawings, but the invention is not limited thereto, but rather, is set forth only by the claims. The drawings described are only schematic and are non-limiting. In the drawings, for illustrative purposes, the size of various elements may be exaggerated and not drawn to a particular scale. It is intended that this invention encompasses inconsequential variations in the relevant tolerances and properties of components and modes of operation thereof. Imperfect practice of the invention is intended to be covered.

Where the term “comprising” is used in the present description and claims, it does not exclude other elements or steps. Where an indefinite or definite article is used when referring to a singular noun, e.g. “a” “an” or “the”, this includes a plural of that noun unless something otherwise is specifically stated. Hence, the term “comprising” should not be interpreted as being restricted to the items listed thereafter; it does not exclude other elements or steps, and so the scope of the expression “a device comprising items A and B” should not be limited to devices consisting only of components A and B. This expression signifies that, with respect to the present invention, the only relevant components of the device are A and B.

What is claimed is:

1. A wireless charging pad comprising:
a power supply; a switch connected to said power supply and capable of turning said power supply on; an NFC tag positioned proximate said switch and capable of turning said switch on in response to an NFC signal.

2. The charging pad of claim 1 in which said switch is a transistor.

3. The charging pad of claim 1 in which said NFC tag is responsive to information about a receiver placed in proximity to said pad.

4. The charging pad of claim 1 further including a coil connected to said power supply and capable of being energized by said power supply.

5. A method of charging a receiver comprising:
providing a charging pad having a power supply; a coil connected to said power supply; a switch connected to said power supply and capable of turning said power supply on; an NFC tag positioned proximate said switch and capable of turning said switch on in response to an NFC signal; whereby if a receiver having NFC transmitting capability is positioned proximate said pad and said receiver transmits an NFC signal, said transistor will turn on said power supply which will energize said coil and charge said receiver.
